(19) United States
(12) Patent Application Publication
(10) Pub. No.: US 2003/0141716 A1
(43) Pub. Date: Jul. 31, 2003

(54) Method and apparatus for repairing a water main break

(76) Inventor: Samuel K. Azar, Clackamas, OR (US)

Correspondence Address: Kolisch Hartwell, P.C., 200 Pacific Building, 520 S. W. Yamhill Street, Portland, OR, 97204, US

(21) Appl. No.: 10/342,693

(22) Filed: Jan. 14, 2003

Related U.S. Application Data
(60) Provisional application No. 60/349,789, filed on Jan. 15, 2002.

(51) Int. Cl. F16L 55/00

(52) U.S. Cl. 285/15

(57) ABSTRACT

A method and apparatus for repairing a water main break are provided. The apparatus includes opposed clamping members actuated by a handle and fastening mechanism. The apparatus may be temporarily positioned at least partially around a break in a water main to thereby contain water gushing out of the break, until a permanent repair band may be positioned over the break.

### CROSS-REFERENCE TO RELATED APPLICATIONS

This application claims priority from U.S. Provisional Patent Application Serial No. 60/349,789, filed on Jan. 15, 2002 the disclosures of which are hereby incorporated by reference.

### TECHNICAL FIELD

The present invention relates generally to repairing pipe breaks, and in particular, to repairing a pressurized water main break.

### BACKGROUND OF THE INVENTION

Due to ground shift, water mains periodically break, causing temporary flooding and water loss to customers. These breaks most often occur as a radial crack around the circumference of the water main.

Prior repair methods required that water to the main be shut off. Before shutting off the water, workers had to notify all affected customers and activate an anti-backflow valve, to prevent water from flowing backwards from a customer's home into the city water main, potentially contaminating the water supply. Workers also had to take precautions to make sure that leaching from local underground gas tanks, oil tanks, etc., would not occur due to the loss in pressure in the water main.

After shutting off the water, the workers would dig out the break, exposing the water main, and place a split sleeve repair band around the crack. Once the repair band was in place, workers would restore pressure to the line, and then flush out the line to remove any contamination. Once the line was clean, workers would contact each customer, and restore each customer's water services, taking care to remove air from the lines and switch off the backflow valve. This entire process was time consuming, taking 3-4 workers approximately 7-8 hours to complete for an average size break.

### SUMMARY OF THE INVENTION

A method and clamp apparatus for repairing a water main break are provided, which may be used to repair a live water main, without shutting off the water pressure to the main. The clamp apparatus includes opposed clamping members actuated by a handle and fastening mechanism. The apparatus may be temporarily positioned at least partially around a break in a water main to contain water gushing out of the break, thereby protecting workers from the harmful, high-pressure spray. With the clamp apparatus temporarily clamped in place, a permanent repair band may be safely positioned around the water main, next to the clamp apparatus. Finally, the temporary clamp may be loosened, and the permanent repair band may be slid over the break and fastened, to permanently repair the break.

### BRIEF DESCRIPTION OF THE DRAWINGS

FIG. 1 is a front view of a clamp apparatus according to one embodiment of the present invention.

FIG. 2 is a bottom, rear perspective view of the clamp apparatus of FIG. 1.

FIG. 3 is a partially disassembled view of the clamp apparatus of FIG. 1, showing a threaded fastener of a fastening mechanism of the clamp apparatus.

FIG. 4 is a top view of the clamp apparatus of FIG. 1.

FIG. 5A is a side view of a water main with a radial break.

FIG. 5B is a side view of the water main of FIG. 5A, with the clamp apparatus of FIG. 1 installed temporarily thereon.

FIG. 5C is a side view of the water main of FIG. 5A, with the clamp apparatus installed temporarily thereon, and a split sleeve repair band positioned adjacent the clamp apparatus.

FIG. 5D is a side view of the water main of FIG. 5A, with the clamp apparatus removed and the split sleeve repair band permanently installed over the radial break.

FIG. 6 is a flowchart of a method for repairing a water main break, according to one embodiment of the present invention.

### DETAILED DESCRIPTION OF THE INVENTION

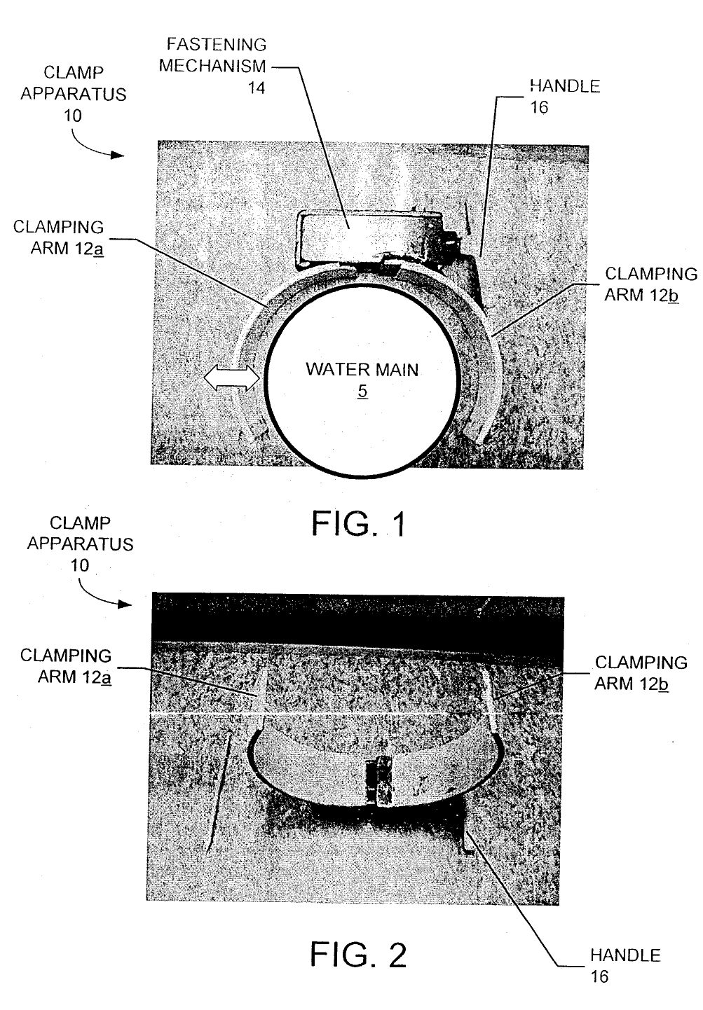

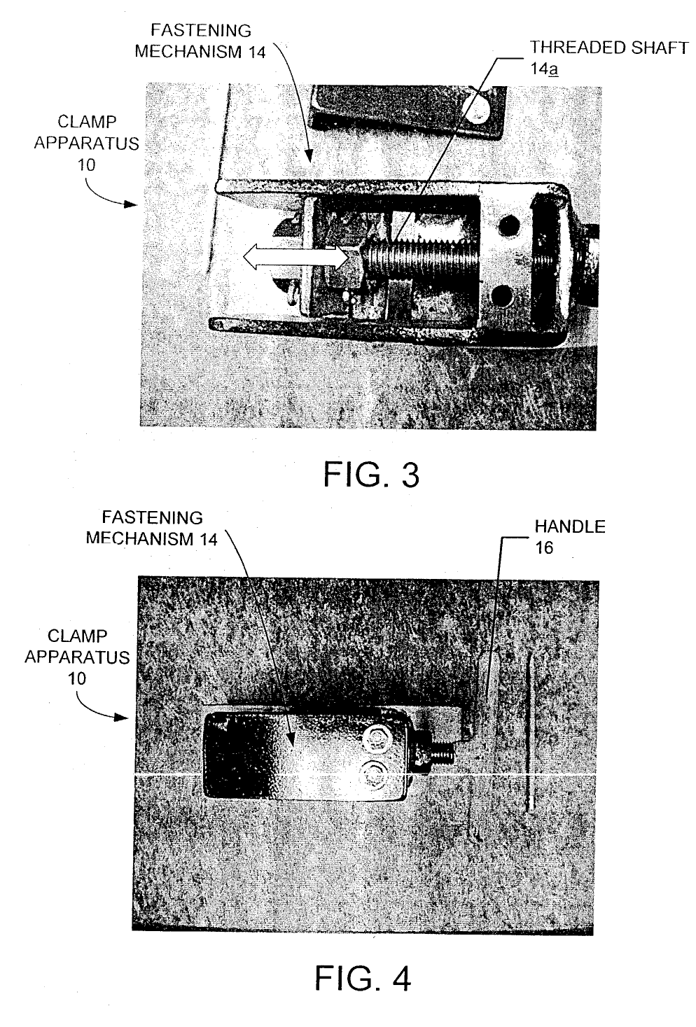

Referring initially to FIGS. 1-4, a clamp apparatus according to one embodiment of the present invention is shown generally at 10. Clamp apparatus 10 includes opposed clamping arms 12a, 12b which may be selectively opened and closed by a fastening mechanism 14, actuated by handle 16, to grip a water main 5. The clamping arms are typically circular and extend around approximately ¾ of the water main. The clamping arms may alternatively have another shape that closely conforms to the outer surface of water main 5.

Handle 16 is attached to a threaded shaft 14a, which in turn guides one of the clamping members back and forth as the handle is rotated. Alternatively, it will be appreciated that fastening mechanism 14 may include a variety of other mechanisms suitable for moving clamping arms 12a, 12b relative to each other.

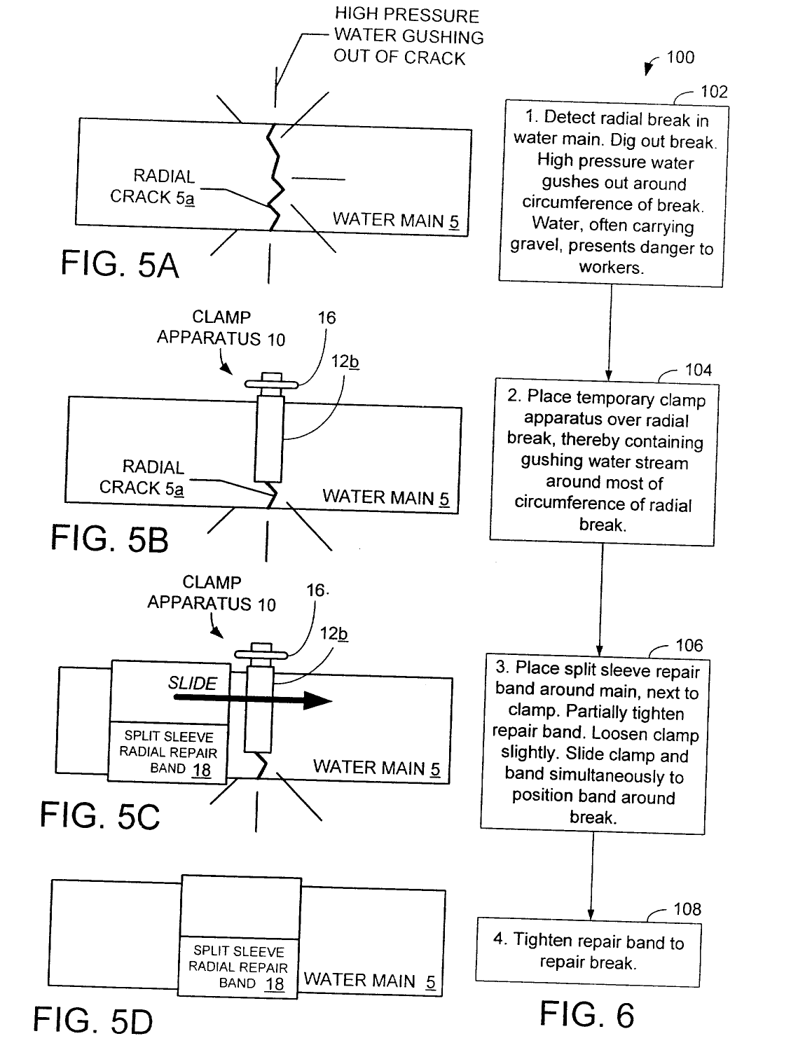

FIGS. 5A-5D and FIG. 6 illustrate a method 100 of repairing a water main break, according to one embodiment of the present invention. As shown in FIG. 5A and at 102 in FIG. 6, the method typically includes detecting a radial break 5a in a water main, and digging out the break to expose the water main. High-pressure water usually gushes out around the circumference of the break. This water, often carrying gravel, may injure workers. To protect workers from this danger, as shown at FIG. 5B and at 104 in FIG. 6, the method further includes placing the temporary clamp apparatus 10 over the break. This is typically accomplished by placing the clamp apparatus on the water main a few inches down from the break, partially tightening the clamp, and sliding the clamp over the gushing water to cover the break. The clamp is tightened down, to substantially contain the water gushing from the break.

As shown in FIG. 5C and at 106 in FIG. 6, the method further includes placing a split sleeve repair band 18 (such as the repair bands commercially available from Romac, Inc. and Ford Meter Box Co.) around the main, adjacent the clamp. The method further includes partially tightening the repair band 18, and loosening the clamp slightly, so that both the repair band and clamp may be slid along the water main. The method further includes sliding the clamp and band simultaneously to position the band around the break. As shown in FIG. 5D and 108 in FIG. 6, the method further includes tightening the band fully to repair the break.

The apparatus and method of the present invention may be used to repair a live water main, without shutting off the water pressure to the main. By repairing the main without shutting off pressure, customers are not inconvenienced by water outages, workers do not have to take the time to notify customers before and after the repair, and contamination concerns due to leaching and backflow into the depressurized main are eliminated. The embodiments of the present invention may be used to repair a typical water main break using 2-3 workers, in approximately 3-4 hours, thus saving time and money, while at the same time avoiding inconvenience to customers.

While the present invention has been particularly shown and described with reference to the foregoing preferred embodiments, those skilled in the art will understand that many variations may be made therein without departing from the spirit and scope of the invention. The description of the invention should be understood to include all novel and non-obvious combinations of elements described herein, and claims may be presented in this or a later application to any novel and non-obvious combination of these elements. Where the claims recite “a ” or “a first ” element or the equivalent thereof, such claims should be understood to include incorporation of one or more such elements, neither requiring nor excluding two or more such elements.

I claim:

1. A temporary clamping apparatus for repairing a water main, the apparatus comprising:
(a) opposed curved clamping arms configured to closely conform to extend more than half way around the circumference of a pipe; and
(b) a fastening mechanism including a handle which, upon rotation, causes the opposed clamping arms to close relative to each other, thereby to clamp the apparatus to the pipe.

2. The temporary clamping apparatus of claim 1, wherein the clamping arms extend more than 180 degrees around the circumference of the pipe and less than 360 degrees around the circumference of the pipe.

3. The temporary clamping apparatus of claim 2, wherein the clamping arms extend 270 degrees around the circumference of the pipe.

4. The temporary clamping apparatus of claim 1, wherein the fastening mechanism includes a threaded shaft coupled with the handle and configured to engage one of the opposed clamping arms to move relative to the other.

5. The temporary clamping apparatus of claim 4, wherein the clamping arm engaged by the threaded shaft is connected with the threaded shaft by a threaded nut attached to the clamping arm.

6. A method for repairing a water main, the method comprising:
(a) placing a temporary clamp apparatus over a break in a live water main, to substantially contain the water gushing from the break, wherein the temporary clamp apparatus includes opposed curved clamping arms configured to extend around and closely conform to the water main, and a fastening mechanism including a handle which, upon rotation, causes the opposed clamping arms to close relative to each other, to thereby clamp the apparatus to the pipe;
(b) placing a permanent repair band around the main, adjacent the clamp;
(c) sliding the clamp and band simultaneously to position band around break; and
(d) tightening the repair band to fully repair the break.
